(19) United States
(12) Patent Application Publication
(10) Pub. No.: US 2026/0244813 A1
(43) Pub. Date: Aug. 20, 2026

(54) STAGE-BY-STAGE HYDRAULIC DESIGN METHOD FOR IMPELLERS OF MULTISTAGE GASLIQUID MULTIPHASE PUMP

(71) Applicant: Jiangsu University, Zhenjiang, Jiangsu (CN)

(72) Inventors: Linlin GENG, Zhenjlang, Jiangsu (CN); Fengming Zheng, Zhenjlang, Jiangsu (CN); Desheng Zhang, Zhenjlang, Jiangsu (CN); Qiang Pan, Zhenjlang, Jiangsu (CN); Guanjian Zhang, Zhenjlang, Jiangsu (CN); Bin XU, Zhenjlang, Jiangsu (CN)

(21) Appl. No.: 19/473,586

(22) PCT Filed: Feb. 27, 2025
(86) PCT No.: PCT/CN2025/079430

§ 371 Date: Oct. 8, 2025

(30) Foreign Application Priority Data
Feb. 18, 2025 (CN) 202510178022.5

(51) Int. Cl. G06F 30/17; F04D 29/22; G06F 30/28; G06F 119/14

(52) U.S. Cl. CPC G06F 30/17; G06F 30/28; F04D 29/2227; G06F 2119/14

(57) ABSTRACT

The present disclosure provides a stage-by-stage hydraulic design method for impellers of a multistage gas-liquid multiphase pump, including the following steps: determining design parameters of the multistage gas-liquid multiphase pump; determining pressurization coefficients of different pressurization stages for the multistage gas-liquid multiphase pump, determining hydraulic design parameters of the different pressurization stages, including volumetric flow rates and pressurization values of the different pressurization stages, stage by stage according to the pressurization coefficients of the different pressurization stages; determining parameters of the impellers of various stages according to gas contents of the impellers of the different pressurization stages; and establishing an impeller model of the multistage gas-liquid multiphase pump according to the parameters of the impellers of the various stages.

### CROSS REFERENCE TO THE RELATED APPLICATIONS

This application is the national phase entry of International Application No. PCT/CN2025/079430, filed on Feb. 27, 2025, which is based upon and claims priority to Chinese Patent Application No. 202510178022.5, filed on Feb. 18, 2025. The entire contents of International Application No. PCT/CN2025/079430 and Chinese Patent Application No. 202510178022.5 are incorporated herein by reference.

### TECHNICAL FIELD

The present disclosure relates to the field of fluid machinery design, and in particular to a stage-by-stage hydraulic design method for impellers of a multistage gas-liquid multiphase pump.

### BACKGROUND

In conventional oil and gas transportation, gas-liquid separation is often performed first, and then the gas phase and the liquid phase are pressurized by a compressor and an oil pump respectively before transportation. However, this transportation method requires a large number of devices and long pipelines. Nowadays, a more advanced transportation method includes first pressurizing a gas-liquid two-phase mixture through a gas-liquid multiphase pump, and then transporting the gas-liquid mixture through a multiphase pipeline. The cost of pipeline laying and subsequent maintenance for this transportation method is much lower than that of the conventional separate transportation of oil and gas. Therefore, the form of oil-gas multiphase transportation is being adopted by more oil and gas fields, and the demand for gas-liquid multiphase pumps is increasing every day.

A gas-liquid multiphase pump generally features a high pressurization capacity and often exists in a multistage form, and has a transported medium being a gas-liquid two-phase fluid with a high gas content; and therefore, its design differs from that of a conventional multistage pump used for transporting a pure liquid. The design of a multistage gas-liquid multiphase pump needs to take into account issues such as the overall volume compression of gas during the stage-by-stage pressurization in the pump, the stage-by-stage reduction in the flow rate, and the decrease in the gas content. Therefore, structural parameters of an impeller of each stage should be adjusted to adapt to incoming flow conditions changing stage by stage. However, a mature hydraulic design method for a multistage gas-liquid multiphase pump has not yet been established at home or abroad.

### SUMMARY

In view of the deficiencies in the prior art, the present disclosure provides a stage-by-stage hydraulic design method for impellers of a multistage gas-liquid multiphase pump. Through stage-by-stage correction of impeller hydraulic designs between different pressurization stages, structural parameters of impellers of different stages are determined, so that the hydraulic design of the multistage impeller may be performed more conveniently to save design time.

The present disclosure achieves the above technical objectives through the following technical means.

A stage-by-stage hydraulic design method for impellers of a multistage gas-liquid multiphase pump is provided, including the following steps:
determining design parameters of the multistage gas-liquid multiphase pump;
determining pressurization coefficients of different pressurization stages for the multistage gas-liquid multiphase pump,
determining hydraulic design parameters of the different pressurization stages, including volumetric flow rates and pressurization values of the different pressurization stages, stage by stage according to the pressurization coefficients of the different pressurization stages;
determining parameters of the impellers of the different pressurization stages according to gas contents of the impellers of the different pressurization stages; and
establishing an impeller model of the multistage gas-liquid multiphase pump according to the parameters of the impellers of the different pressurization stages.

Further, the design parameters of the multistage gas-liquid multiphase pump include an inflow pressure P₀, a multiphase pump pressurization P_{T}, a volumetric flow rate Q, a gas content α, and a total number n of the different pressurization stages,
where the volumetric flow rate Q is equal to Qₗ+Q_{g}, where Qₗ is a liquid flow rate, and Q_{g} is a gas flow rate; and
the gas content α is equal to Q_{g}/Q.

Further, determining the pressurization coefficients of the different pressurization stages for the multistage gas-liquid multiphase pump includes:
setting a pressurization coefficient of an i^{th} stage impeller to aᵢ, i∈(1, 2, . . . n), to allow corresponding pressurization capacities of the different pressurization stages of the multistage gas-liquid multiphase pump to meet the following relational expression:

$${P}_{T} = {P}_{1} + {P}_{2} + … + {P}_{l} + … {P}_{n} = {α}_{1} ( \frac{{P}_{T}}{n} ) + {α}_{2} ( \frac{{P}_{T}}{n} ) + … + {α}_{1} ( \frac{{P}_{T}}{n} ) + … + {α}_{n} ( \frac{{P}_{T}}{n} )$$

where
   Pᵢ=a pressurization value of the i^{th} stage impeller;
   a₁, a₂, a₃, . . . , aₙ are the pressurization coefficients, and meet a relational expression:

$${\sum }_{i = 1}^{n} \frac{{a}_{i}}{n} = 1 ;$$

the pressurization value of the i^{th} stage impeller is:

$${P}_{i} = {a}_{i} ( \frac{{P}_{T}}{n} ) ;$$

a pressurization coefficient of an (i+1)^{th} stage meets aᵢ₊₁=aᵢ*bᵢ, where bᵢ is a pressurization ratio of the i^{th} stage impeller, ranging from 1.0 to 1.8; and
a pressurization value obtained for the (i+1)^{th} stage impeller is

$${P}_{i + 1} = {a}_{i + 1} ( \frac{{P}_{T}}{n} ) ;$$

obtaining the gas content αᵢ₊₁ at an inlet of the (i+1)^{th} stage impeller as follows:

$${α}_{i + 1} = \frac{{Q}_{g} \frac{{p}_{0}}{{p}_{0} + {{\sum }_{i = 1}}^{i} {p}_{i}}}{{Q}_{l} + {Q}_{g} \frac{{p}_{0}}{{p}_{0} + {{\sum }_{i = 1}}^{i} {p}_{i}}} ;$$

and
determining whether the pressurization coefficients of the different pressurization stages meet

$${\sum }_{i = 1}^{n} \frac{{a}_{i}}{n} = 1 ,$$

and if not, adjusting a pressurization coefficient of a 1^{st} stage impeller and pressurization ratios of the different pressurization stages respectively until the pressurization coefficients of the different pressurization stages meet

$${\sum }_{i = 1}^{n} \frac{{a}_{i}}{n} = 1.$$

Further, the pressurization ratio bᵢ of the i^{th} stage impeller ranges from 1.0 to 1.8, the pressurization coefficient a¹ of the 1^{st} stage impeller ranges from 0.6 to 0.9, and a higher gas content at an inlet of the i^{th} stage impeller results in a larger corresponding pressurization ratio of the i^{th} stage impeller.

Further, the hydraulic design parameters of the different pressurization stages, including the volumetric flow rates and pressurization values of the different pressurization stages, are determined stage by stage according to a pressurization coefficient aᵢ of an i^{th} stage impeller, as follows:
a pressurization value Pᵢ of the i^{th} stage impeller is:

$${P}_{i} = {a}_{i} ( \frac{{P}_{T}}{n} ) ;$$

and
a volumetric flow rate Qᵢ of the i^{th} stage impeller meets the following relational expression:

$${Q}_{i} = {Q}_{l} + {Q}_{g} \frac{{p}_{0}}{{p}_{0} + {{\sum }_{i = 1}}^{i - 1} {p}_{i - 1}} ,$$

where i>1.

Further, when a gas content αᵢ of an i^{th} stage impeller is less than or equal to 10%, the structural parameters of the impellers of the different pressurization stages are determined by a specific speed of the i^{th} stage impeller; and when the gas content αᵢ of the i^{th} stage impeller is greater than 10%, the structural parameters of a 1^{st} stage impeller are first determined, and structural parameters of the impellers of the different pressurization stages are corrected.

Further, when the gas content αᵢ of the i^{th} stage impeller is less than or equal to 10%, the specific speed of the i^{th} stage impeller is calculated through the following equation:

$${n}_{s \_ i} = \frac{3.65 {n}_{rotating} \sqrt{{Q}_{i}}}{{( {P}_{i} / g {ρ}_{l} )}^{0.75}}$$

where: n_{s_i} is the specific speed of the i^{th} stage impeller; n_{rotating} is a rotational speed of the i^{th} stage impeller; and ρₗ is a density of a liquid inside the multistage gas-liquid multiphase pump; and
a pump model is selected according to the specific speed of the i^{th} stage impeller, and the structural parameters of the i^{th} stage impeller are determined.

Further, when the gas content αᵢ of the it stage impeller is greater than 10%, the structural parameter of the 1^{st} stage impeller are determined, as follows:
the structural parameters of the 1^{st} stage impeller, including an inlet and outlet diameter D_{s_1} of the 1^{st} stage impeller, a hub equivalent diameter D_{h_l} of the 1^{st} stage impeller, a rim inlet placement angle β_{j_1} of the 1^{st} stage impeller, a rim outlet placement angle β_{c_1} of the 1^{st} stage impeller, a hub cone angle θ₁ of the 1^{st} stage impeller, and a 1^{st} stage blade wrap angle φ₁, are calculated according to a pressurization value P₁, a volumetric flow rate Q, and a gas content α₁ of the 1^{st} stage impeller, as follows: the inlet and outlet diameter D_{s_1} of the 1^{st} stage impeller:

$${D}_{{s}_{-} 1} = {k}_{0} \sqrt[3]{\frac{Q}{{n}_{rotating}}} ;$$

where k₀ is a first coefficient; and n_{rotating} is a rotational speed of the 1^{st} stage impeller; the hub equivalent diameter D_{h_l} of the 1^{st} stage impeller: D_{h_1}=dₛₕD_{s_1};
where dₛₕ is a hub ratio;
the rim inlet placement angle β_{j_1} of the 1^{st} stage impeller:

$${β}_{{j}_{-} 1} = arctan \frac{4 {k}_{1} Q / [ π ( 1 - {d}_{sh}^{2} ) {D}_{s \_ 1}^{2} ]}{π {D}_{s \_ 1} {n}_{rotating} / 60} ;$$

where k₁ is a second coefficient;
the rim outlet placement angle β_{c_1} of the 1^{st} stage impeller:

$${β}_{c \_ 1} = arctan \frac{4 {k}_{2} Q / [ π ( 1 - {d}_{sh} ) {D}_{s \_ 1}^{2} ]}{π {D}_{s} {n}_{rotating} / 60 - 60 g ( {P}_{1} / ( {ρ}_{mix} g ( 1 - {α}_{1} ) ) ) / π {D}_{s \_ 1} {n}_{rotating}} + Δ β$$

where k₂ is a third coefficient; ρₘᵢₓ is the density of a gas-liquid mixture, ρₘᵢₓ=ρ₁ (1−α₁)+ρ_{g} α₁, and Δβ is an angle of attack;
the hub cone angle θ₁ of the 1^{st} stage impeller is 6°-12°; and
the 1^{st} stage blade wrap angle φₗ is 100°-200°.

Further, when the gas content αᵢ of the i^{th} stage impeller is greater than 10%, the structural parameters of the impellers of the different pressurization stages are corrected respectively, as follows:
the different pressurization stages adopt a same inlet and outlet diameter and a same hub ratio for the impellers;
a correction method for a rim inlet placement angle β_{j_1} of the i^{th} stage impeller meets the following equation:

$${β}_{j \_ i} = \sqrt{\frac{{Q}_{i}}{{Q}_{1}}} {β}_{j \_ 1} ;$$

a correction method for a rim outlet placement angle β_{c_i} of the i^{th} stage impeller meets the following equation:

$${β}_{c \_ i} = \frac{{P}_{i} / [ {ρ}_{mix} ( 1 - {α}_{i} ) ]}{{P}_{1} / [ {ρ}_{mix} ( 1 - {α}_{i} ) ]} {β}_{c \_ 1} ;$$

a correction method for a hub cone angle θᵢ₊₁ of the i^{th} stage impeller meets the following equation:

$${θ}_{i + 1} = {k}_{3} \sqrt{\frac{{α}_{i + 1}}{{α}_{i}}} {θ}_{i} ,$$

where k₃ is a fourth coefficient; and
an i^{th} stage blade wrap angle φₗ is 100°-200°, and as the gas content of each of the different pressurization stages decreases stage by stage, φᵢ gradually decreases.

An impeller of a multistage gas-liquid multiphase pump is an impeller determined by the stage-by-stage hydraulic design method for the impellers of the multistage gas-liquid multiphase pump.

The present disclosure has the following advantages.

In response to inflow conditions changing stage by stage in a multistage gas-liquid multiphase pump, the present disclosure proposes a stage-by-stage hydraulic design method for impellers of the multistage pump. Through this method, the changes in inflow parameters of each stage may be fully considered during designing of the multiphase pump, and the structural parameters of each stage of the multiphase pump may be designed stage by stage, so that the impeller of each stage may better match the inflow conditions of each stage, ensuring that the impeller of each stage of the multiphase pump operates in a high-efficiency zone. This design method can ensure the design of a multistage gas-liquid multiphase pump that operates more efficiently.

### BRIEF DESCRIPTION OF THE DRAWINGS

In order to provide a clearer explanation of the embodiments of the present disclosure or the technical solutions in the prior art, a brief introduction will be given to the accompanying drawings required for the description of the embodiments or the prior art. The accompanying drawings in the following description are some embodiments of the present disclosure. For those skilled in the art, it is obvious that other drawings can be obtained based on these drawings without creative labor.

FIG. 1 is a flowchart of a stage-by-stage hydraulic design method for impellers of a multistage gas-liquid multiphase pump according to the present disclosure.

FIG. 2 is an axial sectional diagram of an impeller of a multiphase pump according to an embodiment of the present disclosure.

FIG. 3 is a schematic diagram of rim inlet and outlet placement angles of an impeller of a multiphase pump according to an embodiment of the present disclosure.

FIG. 4 is a schematic diagram of a blade wrap angle of an impeller of a multiphase pump according to an embodiment of the present disclosure.

### DETAILED DESCRIPTION OF THE EMBODIMENTS

The embodiments of the present disclosure are described in detail below, and examples of the embodiments are shown in the accompanying drawings, where the same or similar reference numerals throughout represent the same or similar elements or elements with the same or similar functions. The embodiments described below with reference to the accompanying drawings are exemplary and intended to explain the present disclosure, and should not be construed as limiting the present disclosure.

In the description of the present disclosure, it should be understood that the terms “center”, “longitudinal”, “transverse”, “length”, “width”, “thickness”, “up”, “down”, “axial”, “radial”, “vertical”, “horizontal”, “inside”, “outside” and other directional or positional relationships referred to are based on the directional or positional relationships shown in the accompanying drawings, only for the convenience of describing the present disclosure and simplifying the description, and do not indicate or imply that the apparatus or element referred to must have a specific orientation, be constructed and operated in a specific orientation, and therefore cannot be understood as a limitation of the present disclosure. In addition, the terms “first” and “second” are only used for descriptive purposes and cannot be understood as indicating or implying relative importance or implying the number of technical features indicated. Thus, the features limited to “first” and “second” may explicitly or implicitly include one or more of these features. In the description of the present disclosure, “a plurality of” means two or more, unless otherwise specifically limited.

In the present disclosure, unless otherwise specified and limited, the terms “install”, “connection”, “connect”, “fix”, and the like should be broadly understood, for example, it can be a fixed connection, a detachable connection, or an integral connection; it can be a mechanical connection or an electrical connection; it can be a direct connection, an indirect connection through an intermediate medium, or a communication between interiors of two elements. For those of ordinary skill in the art, the specific meanings of the above terms in the present disclosure can be understood according to specific situations.

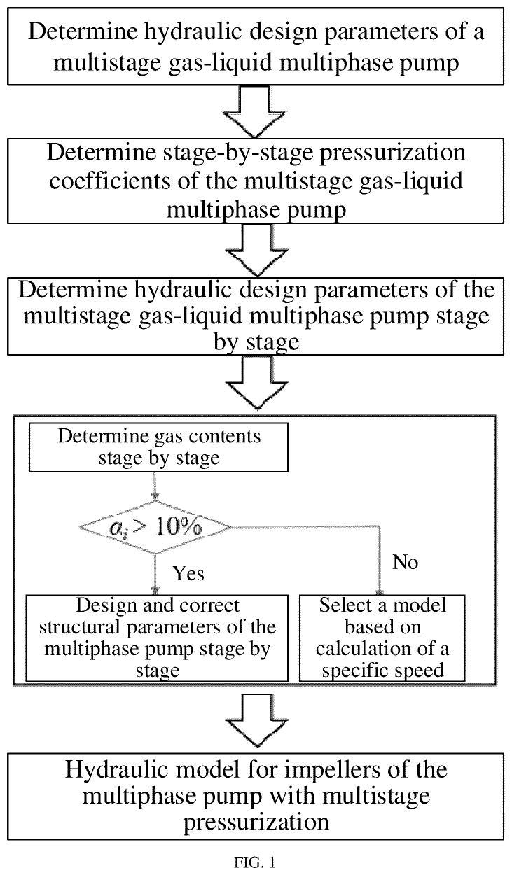

As shown in FIG. 1, a stage-by-stage hydraulic design method for impellers of a multistage gas-liquid multiphase pump according to the present disclosure includes the following steps:

S01: Design parameters of the multistage gas-liquid multiphase pump, including a volumetric flow rate, a multiphase pump pressurization, and a gas content, are determined.

The hydraulic design parameters of the multistage gas-liquid multiphase pump include an inflow pressure P₀, the multiphase pump pressurization P_{T}, the volumetric flow rate Q, the gas content α, and the total number n of pressurization stages, where the volumetric flow rate Q is equal to Qₗ+Q_{g}, where Qₗ is a liquid flow rate, and Q_{g} is a gas flow rate; and the gas content α is equal to Q_{g}/Q. The gas content α here can be understood as a gas content of a 1^{st} stage impeller, that is, αᵢ.

S02: Pressurization coefficients of different pressurization stages for the multistage multiphase gas-liquid pump are determined, specifically as follows:

A pressurization coefficient of an i^{th} stage impeller is set to αᵢ, i∈(1, 2, . . . , n), to allow the corresponding pressurization capacities of the various stages of the multistage gas-liquid multiphase pump to meet the relational expression:

$${P}_{T} = {P}_{1} + {P}_{2} + … + {P}_{i} + … {P}_{n} = {a}_{1} ( \frac{{P}_{T}}{n} ) + {a}_{2} ( \frac{{P}_{T}}{n} ) + … + {a}_{i} ( \frac{{P}_{T}}{n} ) + … + {a}_{n} ( \frac{{P}_{T}}{n} )$$

where
   Pᵢ=the pressurization value of the i^{th} stage impeller;
   a₁, a₂, a₃, . . . , aₙ are the pressurization coefficients, and meet a relational expression:

$${\sum }_{i = 1}^{n} \frac{{a}_{i}}{n} = 1 ;$$

and
the pressurization coefficient of an (i+1)^{th} stage meets aᵢ₊₁=aᵢ*bᵢ, where bᵢ is a pressurization ratio of the i^{th} stage impeller, ranging from 1.0 to 1.8.

The pressurization coefficient a₁ of 1^{st} stage impeller is generally 0.6-0.9, and a higher gas content results in a smaller selected value of a₁. The higher the gas content at an inlet of the pressurization stage is, the larger the corresponding pressurization ratio is. When the gas content is lower than 0.1, the pressurization ratio becomes closer to 1.

The pressurization value of the 1^{st} stage impeller is:

$${P}_{1} = {a}_{1} ( \frac{{P}_{T}}{n} ) .$$

According to the pressurization value of the 1^{st} stage impeller, a gas content at a 2^{nd} stage inlet can be calculated using the following calculation method:

$${α}_{2} = \frac{{Q}_{g} \frac{{p}_{0}}{{p}_{0} + {p}_{1}}}{{Q}_{l} + {Q}_{g} \frac{{p}_{0}}{{p}_{0} + {p}_{1}}} .$$

A corresponding pressurization ratio b₂ is initially selected according to the gas content α₂ at the 2^{nd} stage inlet, and a 2^{nd} stage pressurization coefficient α₂ can be obtained by calculation. By obtaining α₂, a 2^{nd} stage pressurization value P₂ can be calculated, and by analog, the pressurization value Pᵢ₊₁ of the (i+1)^{th} stage impeller and the gas content αᵢ₊₁ of the (i+1)^{th} stage impeller are obtained.

The expression for the gas content αᵢ₊₁ of the (i+1)^{th} stage impeller is:

$${α}_{i + 1} = \frac{{Q}_{g} \frac{{p}_{0}}{{p}_{0} + {\sum }_{i = 1}^{i} {p}_{1}}}{{Q}_{l} + {Q}_{g} \frac{{p}_{0}}{{p}_{0} + {\sum }_{i = 1}^{i} {p}_{1}}} .$$

The pressurization ratio of each stage is selected and the pressurization coefficient of each stage is calculated in sequence, and finally whether the pressurization coefficients of the stages meet

$${\sum }_{i = 1}^{n} \frac{{a}_{i}}{n} = 1$$

is determined. If it is not satisfied, the pressurization coefficient of the 1^{st} stage impeller and the pressurization ratio of each stage are fine tuned until the pressurization coefficients of the stages meet

$${\sum }_{i = 1}^{n} \frac{{a}_{i}}{n} = 1 .$$

S03: Hydraulic design parameters of the different pressurization stages, including volumetric flow rates and pressurization values of the different pressurization stages, are determined stage by stage according to the i^{th} impeller pressurization coefficient aᵢ.

The pressurization value Pᵢ of the i^{th} stage impeller is:

$${P}_{i} = {a}_{i} ( \frac{{P}_{T}}{n} ) ;$$

and
the volumetric flow rate Qₗ of the i^{th} stage impeller meets the following relational expression:

$${Q}_{i} = {Q}_{l} + {Q}_{9} \frac{{p}_{0}}{{p}_{0} + {{\sum }_{i = 1}}^{i - 1} {p}_{i - 1}} ,$$

where i>1.

S04: Parameters of impellers of various stages are determined.

S04.1: When the gas content αᵢ of the i^{th} stage impeller is less than or equal to 10%, a specific speed of the i^{th} stage impeller can be calculated through the following equation,

$${n}_{s \_ i} = \frac{3.65 {n}_{rotating} \sqrt{{Q}_{i}}}{{( {P}_{i} / g {ρ}_{l} )}^{0.75}}$$

where n_{s_i} is the specific speed of the i^{th} stage impeller; n_{rotating} is the rotational speed of the impeller; and ρₗ is a density of a liquid inside the pump.

A pump model is selected according to the obtained i^{th} stage impeller specific speed, and parameters such as an impeller diameter, a hub ratio, blade inlet and outlet placement angles, a hub cone angle, and a blade wrap angle of the i^{th} stage impeller are determined.

S04.2: When the gas content αᵢ of the i^{th} stage impeller is greater than 10%, structural parameters of the 1^{st} stage impeller are determined first, and then the structural parameters of the impeller of each stage are corrected, specifically as follows:

S04.2.1: The structural parameters of the 1^{st} stage impeller, including an inlet and outlet diameter D_{s_1} of the 1^{st} stage impeller, a hub equivalent diameter D_{h_l} of the 1^{st} stage impeller, a rim inlet placement angle β_{j_1} of the 1^{st} stage impeller, a rim outlet placement angle β_{c_1} of the 1^{st} stage impeller, a hub cone angle θ₁ of the 1^{st} stage impeller, and a 1^{st} stage blade wrap angle φ₁, are calculated according to the pressurization value P₁ of the 1^{st} stage impeller, the volumetric flow rate Q, and the gas content α₁ of the 1^{st} stage impeller, specifically as follows:

The inlet and outlet diameter is D_{s_1} of the 1^{st} stage impeller:

$${D}_{s \_ 1} = {k}_{0} \sqrt[3]{\frac{Q}{{n}_{rotating}}} ;$$

where k₀ is a first coefficient, k₀=7-10; n_{rotating} is the rotational speed of the impeller; and selection of k₀ is related to the flow rate and the gas content.

The hub equivalent diameter of the 1^{st} stage impeller is D_{h_1}: D_{h_1}=dₛₕD_{s_1};
where dₛₕ is a hub ratio; dₛₕ=0.75-0.9, and a higher gas content results in a larger value. The rim inlet placement angle of the 1^{st} stage impeller β_{j_1}:

$${β}_{j \_ 1} = arctan \frac{4 {k}_{1} Q / [ π ( 1 - {d}_{sh}^{2} ) {D}_{s \_ 1}^{2} ]}{π {D}_{s \_ 1} {n}_{rotating} / 60} ;$$

where k₁ is a second coefficient, and k₁=0.6-1.0.

The rim outlet placement angle of the 1^{st} stage impeller β_{c_1}:

$${β}_{c \_ 1} = arctan \frac{4 {k}_{2} Q / [ π ( 1 - {d}_{sh} ) {D}_{s \_ 1}^{2} ]}{π {D}_{s \_ 1} {n}_{rotating} / 60 - 60 g ( {P}_{1} / ( {ρ}_{mix} g ( 1 - {α}_{1} ) ) ) / π {D}_{s \_ 1} {n}_{rotating}} + Δ β$$

where k₂ is a third coefficient, k₂=1.0-2.0; ρₘᵢₓ is a density of a gas-liquid mixture, ρₘᵢₓ=ρ₁ (1−α₁)+ρ_{g}α₁, and Δβ is an angle of attack, ranging from 0° to 3°.

After the rim inlet placement angle of the 1^{st} stage impeller is obtained, the inlet and outlet placement angles for different blade heights are respectively calculated through an equation: d tanβ=constant.

The hub cone angle of the 1^{st} stage impeller is θ₁=6°-12°, and a higher gas content results in a larger cone angle θ₁.

The 1^{st} stage blade wrap angle φ₁ is 100°-200°, and the value is related to the number of blades and the gas content, and a higher gas content results in a larger blade wrap angle.

S04.2.2: The structural parameters of impellers of the different pressurization stages are corrected by a stage-by-stage correction method, specifically as follows:

Each stage adopts the same inlet and outlet diameter and the same hub ratio for the impellers; a correction method for a rim inlet placement angle β_{j_i} of the i^{th} stage impeller meets the following equation:

$${β}_{j \_ i} = \sqrt{\frac{{Q}_{i}}{{Q}_{1}}} {β}_{j \_ 1} ;$$

a correction method for a rim outlet placement angle β_{c_i} of the i^{th} stage impeller meets the following equation:

$${β}_{c \_ i} = \frac{{P}_{i} / [ {ρ}_{mix} ( 1 - {α}_{i} ) ]}{{P}_{1} / [ {ρ}_{mix} ( 1 - {α}_{i} ) ]} {β}_{c \_ 1} ;$$

a correction method for a hub cone angle θᵢ₊₁ of the i^{th} stage impeller meets the following equation:

$${θ}_{i + 1} = {k}_{3} \sqrt{\frac{{α}_{i + 1}}{{α}_{i}}} {θ}_{i} ,$$

where k₃ is a fourth coefficient, k₃=0.8-1.2; and
a method of selecting an i^{th} stage blade wrap angle meets the following criteria: the blade wrap angle φᵢ=100°-200°, and as the gas content of each stage decreases stage by stage, φᵢ gradually decreases.

S05: A hydraulic model for the impellers of the multistage gas-liquid multiphase pump is determined according to the structural parameters of the impellers of different pressurization stages.

### Embodiment

Taking design parameters of a multistage pump as an example: an inflow pressure is 100000 Pa, a design flow rate is 150 m³/h, a gas content is 0.5, a rotational speed is 3000 r/min, a required pressurization is 500000 Pa, and the number of pump pressurization stages is 4.

S01: Design parameters of a multistage gas-liquid multiphase pump, including a volumetric flow rate, a multiphase pump pressurization, and a gas content, are determined, specifically as follows:

An incoming pressure is P₀=1 atm; the multiphase pump pressurization is P_{T}=5 atm; the volumetric flow rate is Q=Qₗ+Q_{g}=150 m³/h; the gas content is α=0.5=α₁; the total number of pressurization stages is n=4; and the rotational speed of the impeller is n_{rotating}=3000 r/min. The volumetric flow rate Q is generally a 1^{st} stage volumetric flow rate Q₁.

S02: Pressurization coefficients of different pressurization stages for the multistage gas-liquid multiphase pump are determined, specifically as follows:

Due to the high gas content of the incoming flow, α=0.5, a smaller 1^{st} stage pressurization coefficient α₁=0.7 is selected, and a corresponding 1^{st} stage pressurization value is:

$${P}_{1} = {a}_{1} ( \frac{{P}_{T}}{n} ) = 0.7 \times ( \frac{500000}{4} ) Pa = 87500 Pa ;$$

and
a corresponding gas content at a 2^{nd} stage inlet is:

$${α}_{2} = \frac{{Q}_{g} \frac{{p}_{0}}{{p}_{0} + {p}_{1}}}{{Q}_{l} + {Q}_{g} \frac{{p}_{0}}{{p}_{0} + {p}_{1}}} = \frac{75 \times \frac{1}{1 + 0.875}}{75 + 75 \times \frac{1}{1 + 0.875}} = 0.348 .$$

At this point, the gas content at the 2^{nd} stage inlet is still relatively high, a 2^{nd} stage pressurization ratio b₂=1.5 is selected, and the corresponding 2^{nd} stage pressurization coefficient a₂ is 1.05. Therefore, the 2^{nd} stage pressurization value can be calculated by:

$${P}_{2} = {a}_{2} ( \frac{{P}_{T}}{n} ) = 1.05 \times ( \frac{500000}{4} ) Pa = 131000 P a .$$

A gas content at a 3^{rd} stage inlet can be obtained by:

$${α}_{3} = \frac{{Q}_{g} \frac{{p}_{0}}{{p}_{0} + {p}_{1} + {p}_{2}}}{{Q}_{l} + {Q}_{g} \frac{{p}_{0}}{{p}_{0} + {p}_{1} + {p}_{2}}} = \frac{75 \times \frac{1}{1 + 0.8 \; 75 + 1.31}}{75 + 75 \times \frac{1}{1 + 0.8 \; 75 + 1.31}} = 0.239 .$$

The gas content at the 3^{rd} stage inlet decreases to 0.239, a third pressurization ratio b₃=1.2 is selected, and a corresponding 3^{rd} stage pressurization coefficient a₃ is 1.26. Therefore, a 3^{rd} stage pressurization value can be calculated as:

$${P}_{3} = {a}_{3} ( \frac{{P}_{T}}{n} ) = 1.26 \times ( \frac{500000}{4} ) Pa = 157500 P a .$$

The gas content at a 4^{th} stage inlet can be obtained by:

$${α}_{4} = \frac{{Q}_{g} \frac{{p}_{0}}{{p}_{0} + {p}_{1} + {p}_{2} + {p}_{3}}}{{Q}_{l} + {Q}_{g} \frac{{p}_{0}}{{p}_{0} + {p}_{1} + {p}_{2} + {p}_{3}}} = \frac{75 \times \frac{1}{1 + 0.8 \; 75 + 1.31 + 1.575}}{75 + 75 \times \frac{1}{1 + 0.8 \; 75 + 1.31 + 1.575}} = 0.174 .$$

The gas content at the 4^{h} stage inlet decreases to 0.174. Considering that the total number of pressurization stages is 4 and the total pressurization value that needs to be met is 500000 Pa, a 4^{th} stage pressurization value P₄ can be calculated as 124000 Pa, while a fourth pressurization ratio b₄ is 0.787, which is not within a pressurization range of 1 to 1.5. Therefore, according to the above steps, the 1^{st} stage pressurization coefficient a₁ and the pressurization ratios of the various stages are corrected again, and the pressurization coefficient, the pressurization ratio, and the total pressurization value of each stage are calculated to meet the limiting conditions.

By following the above steps, the 1^{st} stage pressurization coefficient is adjusted to a₁=0.6, and b₂=1.5, b₃=1.3, and b₄=1.14. The calculated pressurization coefficient for each of the stages is a₂=0.9, a₃=1.17, and a₄=1.33, respectively.

The pressurization coefficients of the stages meet

$${\sum }_{i = 1}^{n} \frac{{a}_{i}}{n} = 1 .$$

S03: Hydraulic design parameters of the different pressurization stages, including volumetric flow rates and pressurization values of the different pressurization stages, are determined stage by stage according to the i^{th} impeller pressurization coefficient αᵢ.

The pressurization value Pᵢ of the i^{th} stage impeller is:

$${P}_{i} = {a}_{i} ( \frac{{P}_{T}}{n} ) ;$$

and
the volumetric flow rate Qₗ of the i^{th} stage impeller meets the following relational expression:

$${Q}_{i} = {Q}_{l} + {Q}_{g} \frac{{p}_{0}}{{p}_{0} + {\sum }_{i = 1}^{i - 1} {p}_{i - 1}} .$$

Calculation results are shown in Table 1:

TABLE 1
Stage-by-Stage Hydraulic Design Parameters of Multistage Pump

| Pressurization | Pressurization | Pressurization | Flow | Gas |
|---|---|---|---|---|
| Stage | Coefficient | Value (Pa) | Rate (m³/h) | Content |
| 1 | 0.6 | 75000 | 150.00 | 0.50 |
| 2 | 0.9 | 112500 | 117.86 | 0.36 |
| 3 | 1.17 | 146250 | 101.09 | 0.26 |
| 4 | 1.33 | 166250 | 92.29 | 0.19 |

S04: Parameters of impellers of various stages are determined.

As shown in Table 1, since the gas content αᵢ of the impeller of each stage is greater than 10%, the structural parameters of the 1^{st} stage impeller are determined first, and then the structural parameters of the impeller of each stage are corrected, specifically as follows.

The design parameters for the 1^{st} stage impeller are: P₁=75000 Pa; Q=150 m³/h; α₁=0.5; and n_{rotating}=3000 r/min.

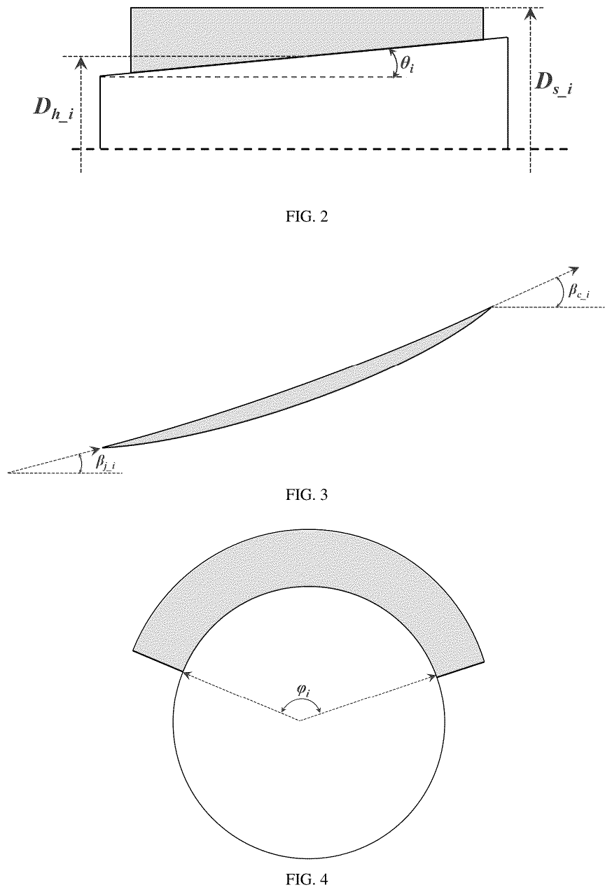

First, as shown in FIG. 2, FIG. 3, and FIG. 4, the first k₀=8.32 is selected according to the volumetric flow rate and the gas content, and the inlet and outlet diameter D_{s_1} of the 1^{st} stage impeller is calculated:

$${D}_{s\_ 1} = {k}_{0} \sqrt[3]{\frac{Q}{{n}_{rotating}}} = 8.32 \times \sqrt[3]{\frac{150 / 3600}{3000}} \times 1000 mm = 200 mm .$$

Second, dₛₕ=0.875 is selected, and the hub equivalent diameter D_{h_l} of the 1^{st} stage impeller is obtained:

$${D}_{h \_ 1} = {d}_{sh} {D}_{s \_ 1} = 0.875 \times 200 mm = 175 mm .$$

By selecting k₁=0.75, the rim inlet placement angle β_{j_1} of the 1^{st} stage impeller equal to 6° can be obtained.

By selecting k₂=1.8, and an outlet angle of attack is Δβ=2°, the rim outlet placement angle, β_{c_1} of the 1^{st} stage impeller equal to 13° is obtained.

The hub cone angle θ₁ of the 1^{st} stage impeller is 8°, and the 1^{st} stage blade wrap angle β1 is 1500.

S04.2.2: The structural parameters of impellers of different pressurization stages are corrected by a stage-by-stage correction method, specifically as follows:

Each stage adopts the same inlet and outlet diameter and the same hub ratio for the impellers; and
according to the volumetric flow rate Q₂ of the 2^{nd} stage impeller, a rim inlet placement angle of the 2^{nd} stage impeller is obtained as follows:

$${β}_{j \_ 2} = \sqrt{\frac{{Q}_{i}}{{Q}_{1}}} {β}_{j \_ 1} = \sqrt{\frac{117.86}{150}} \times {6}^{°} = 5 . {3}^{°} .$$

A rim inlet placement angle β_{j_3} of the 3^{rd} stage impeller equal to 4.9° and a rim inlet placement angle β_{j_4} of the 4^{th} stage impeller equal to 4.7° can also be obtained by calculation sequentially.

According to the gas content of the 2^{nd} stage impeller, the pressurization value of the 2^{nd} stage impeller, and the rim outlet placement angle of the 1^{st} stage impeller, the rim outlet placement angle β_{c_2} of the 2^{nd} stage impeller is obtained:

$${β}_{c\_ i} = \frac{{P}_{i} / [ {ρ}_{mix} ( 1 - {α}_{i} ) ]}{{P}_{1} / [ {ρ}_{mix} ( 1 - {α}_{i} ) ]} {β}_{c \_ 1} = \frac{112500 / [ 640 \times ( 1 - 0.36 ) ]}{75000 / [ 500.6 \times ( 1 - 0.5 ) ]} \times {13}^{°} = {12.2}^{°} .$$

A rim outlet placement angle β_{c_3} of the 3^{rd} stage impeller equal to 11.8° and a rim outlet placement angle β_{c_4} of the 4^{th} stage impeller equal to 11.1° can also be obtained by calculation sequentially.

According to the gas content of each stage and by selecting the appropriate k₃, the impeller hub cone angles can be calculated stage by stage as follows: a hub cone angle θ₂ of the 2^{nd} stage impeller is 6.5°, a hub cone angle θ₃ of the 3^{rd} stage impeller is 5.5°, and a hub cone angle θ₄ of the 4^{th} stage impeller is 4.5°.

Blade wrap angles for the second, third, and fourth stages are selected as follows: a 2^{nd} stage blade wrap angle is φ₂=130°, a 3^{rd} stage blade wrap angle is φ₃=120°, and a 4^{th} stage blade wrap angle is φ₄=110°.

The hydraulic structural parameters of the impellers at all pressurization stages in the multistage pump are determined, and results are shown in Table 2.

TABLE 2
Stage-by-Stage Impeller Structural Parameters for Multistage Pump

| | | | Rim Inlet | Rim Outlet | Hub | |
|---|---|---|---|---|---|---|
| Pressurization | Rim | Hub | Placement | Placement | Inclination | Wrap |
| Stage | Diameter | Ratio | Angle | Angle | Angle | Angle |
| 1 | 200 mm | 0.875 | 6° | 13° | 8° | 150° |
| 2 | 200 mm | 0.875 | 5.3° | 12.2° | 6.5° | 130° |
| 3 | 200 mm | 0.875 | 4.9° | 11.8° | 5.5° | 120° |
| 4 | 200 mm | 0.875 | 4.7° | 11.1° | 4.5° | 110° |

S05: A hydraulic model for the impeller of the multistage gas-liquid multiphase pump is determined according to the structural parameters of the impellers of the different pressurization stages.

An impeller of a multistage gas-liquid multiphase pump is an impeller determined by the stage-by-stage hydraulic design method for the impellers of the multistage gas-liquid multiphase pump according to the present disclosure.

It should be understood that although this specification is described in terms of various embodiments, each embodiment does not merely contain an independent technical solution. This way of presentation in the specification is only for the sake of clarity. Those skilled in the art should consider the specification as a whole, and the technical solutions in the various embodiments can also be appropriately combined to form other implementations that can be understood by those skilled in the art.

The series of detailed descriptions listed above are only specific explanations for the feasible embodiments of the present disclosure, and they are not intended to limit the protection scope of the present disclosure. All equivalent embodiments or changes made without departing from the technical spirit of the present disclosure shall be included in the protection scope of the present disclosure.

1. A stage-by-stage hydraulic design method for impellers of a multistage gas-liquid multiphase pump, comprising the following steps:
determining design parameters of the multistage gas-liquid multiphase pump;
determining pressurization coefficients of different pressurization stages for the multistage gas-liquid multiphase pump;
determining hydraulic design parameters of the different pressurization stages, comprising volumetric flow rates and pressurization values of the different pressurization stages, stage by stage according to the pressurization coefficients of the different pressurization stages;
determining structural parameters of the impellers of the different pressurization stages according to gas contents of the impellers of the different pressurization stages; and
establishing an impeller model of the multistage gas-liquid multiphase pump according to the structural parameters of the impellers of the different pressurization stages, wherein
determining the pressurization coefficients of the different pressurization stages for the multistage gas-liquid multiphase pump comprises:
setting a pressurization coefficient of an i^{th} stage impeller to aᵢ, i∈(1, 2, . . . , n), to allow corresponding pressurization capacities of the different pressurization stages of the multistage gas-liquid multiphase pump to meet the following relational expression:
$${P}_{T} = {P}_{1} + {P}_{2} + … + {P}_{i} + … {P}_{n} = {a}_{1} ( \frac{{P}_{T}}{n} ) + {a}_{2} ( \frac{{P}_{T}}{n} ) + … + {a}_{i} ( \frac{{P}_{T}}{n} ) + … + {a}_{n} ( \frac{{P}_{T}}{n} )$$
wherein:
Pₗ=a pressurization value of the i^{th} stage impeller;
a₁, a₂, a₃, . . . , aₙ are the pressurization coefficients, and meet a relational expression:
$${\sum }_{i = 1}^{n} \frac{{a}_{i}}{n} = 1 ;$$
the pressurization value of the i^{th} stage impeller is:
$${P}_{i} = {a}_{i} ( \frac{{P}_{T}}{n} ) ;$$
a pressurization coefficient of an (i+1)^{th} stage impeller meets aᵢ₊₁=aᵢ*bᵢ, wherein bᵢ is a pressurization ratio of the i^{th} stage impeller, ranging from 1.0 to 1.8; and
a pressurization value obtained for the (i+1)^{th} stage impeller is
$${P}_{i + 1} = {a}_{i + 1} ( \frac{{P}_{T}}{n} ) ;$$
obtaining a gas content αᵢ₊₁ at an inlet of the (i+1)^{th} stage impeller as follows:
$${α}_{i + 1} = \frac{{Q}_{g} \frac{{p}_{0}}{{p}_{0} + {\sum }_{i = 1}^{i} {p}_{i}}}{{Q}_{l} + {Q}_{g} \frac{{p}_{0}}{{p}_{0} + {\sum }_{i = 1}^{i} {p}_{i}}} ;$$
and
determining whether the pressurization coefficients of the different pressurization stages meet
$${\sum }_{i = 1}^{n} \frac{{a}_{i}}{n} = 1 ,$$
and if not, adjusting a pressurization coefficient of a 1^{st} stage impeller and pressurization ratios of the different pressurization stages respectively until the pressurization coefficients of the different pressurization stages meet
$${\sum }_{i = 1}^{n} \frac{{a}_{i}}{n} = 1.$$

2. The stage-by-stage hydraulic design method for the impellers of the multistage gas-liquid multiphase pump according to claim 1, wherein the design parameters of the multistage gas-liquid multiphase pump comprise an inflow pressure P₀, a multiphase pump pressurization P_{T}, a volumetric flow rate Q, a gas content α, and a total number n of the different pressurization stages,
wherein the volumetric flow rate Q is equal to Qₗ+Q_{g}, wherein Qₗ is a liquid flow rate, and Q_{g} is a gas flow rate; and
the gas content α is equal to Q_{g}/Q.

3. (canceled)

4. The stage-by-stage hydraulic design method for the impellers of the multistage gas-liquid multiphase pump according to claim 1, wherein the pressurization ratio bᵢ of the i^{th} stage impeller ranges from 1.0 to 1.8, the pressurization coefficient a₁ of the 1^{st} stage impeller ranges from 0.6 to 0.9, and a higher gas content at an inlet of the i^{th} stage impeller results in a larger corresponding pressurization ratio of the i^{th} stage impeller.

5. The stage-by-stage hydraulic design method for the impellers of the multistage gas-liquid multiphase pump according to claim 1, wherein the hydraulic design parameters of the different pressurization stages, comprising the volumetric flow rates and the pressurization values of the different pressurization stages, are determined stage by stage according to the pressurization coefficient aᵢ of the i^{th} stage impeller, as follows:
the pressurization value Pᵢ of the i^{th} stage impeller is:
$${P}_{i} = {a}_{i} ( \frac{{P}_{T}}{n} ) ;$$
and
a volumetric flow rate Qᵢ of the i^{th} stage impeller meets the following relational expression:
$${Q}_{i} = {Q}_{l} + {Q}_{g} \frac{{p}_{0}}{{p}_{0} + {\sum }_{i = 1}^{i - 1} {p}_{i - 1}} ,$$
wherein i>1.

6. The stage-by-stage hydraulic design method for the impellers of the multistage gas-liquid multiphase pump according to claim 1, wherein when a gas content αᵢ of the i^{th} stage impeller is less than or equal to 10%, the structural parameters of the impellers of the different pressurization stages are determined by a specific speed of the i^{th} stage impeller; and when the gas content αᵢ of the i^{th} stage impeller is greater than 10%, the structural parameters of the 1^{st} stage impeller are first determined, and the structural parameters of the impellers of the different pressurization stages are corrected.

7. The stage-by-stage hydraulic design method for the impellers of the multistage gas-liquid multiphase pump according to claim 6, wherein when the gas content αᵢ of the i^{th} stage impeller is less than or equal to 10%, the specific speed of the i^{th} stage impeller is calculated through the following equation:
$${n}_{s \_ i} = \frac{3.65 {n}_{rotating} \sqrt{{Q}_{i}}}{{( {P}_{i} / {g ρ}_{l} )}^{0.75}}$$
wherein: n_{s_i} the specific speed of the i^{th} stage impeller; n_{rotating} is a rotational speed of the i^{th} stage impeller; and ρₗ is a density of a liquid inside the multistage gas-liquid multiphase pump; and
a pump model is selected according to the specific speed of the i^{th} stage impeller, and the structural parameters of the i^{th} stage impeller are determined.

8. The stage-by-stage hydraulic design method for the impellers of the multistage gas-liquid multiphase pump according to claim 6, wherein when the gas content αᵢ of the i^{th} stage impeller is greater than 10%, the structural parameters of the 1^{st} stage impeller are determined, as follows:
the structural parameters of the 1^{st} stage impeller, comprising an inlet and outlet diameter D_{s_1} of the 1^{st} stage impeller, a hub equivalent diameter D_{h_1} of the 1^{st} stage impeller, a rim inlet placement angle β_{j_1} of the 1^{st} stage impeller, a rim outlet placement angle β_{c_1} of the 1^{st} stage impeller, a hub cone angle θ₁ of the 1^{st} stage impeller, and a 1^{st} stage blade wrap angle φ₁, are calculated according to a pressurization value P₁, a volumetric flow rate Q, and a gas content α₁ of the 1^{st} stage impeller, as follows:
the inlet and outlet diameter D_{s_1} of the 1^{st} stage impeller:
$${D}_{s \_l} = {k}_{0} \sqrt[3]{\frac{Q}{{n}_{rotating}}} ;$$
wherein k₀ is a first coefficient; and n_{rotating} is a rotational speed of the 1^{st} stage impeller;
the hub equivalent diameter D_{h_1} of the 1^{st} stage impeller: D_{h_1}=dₛₕD_{s_1};
wherein dₛₕ is a hub ratio;
the rim inlet placement angle β_{j_1} of the 1^{st} stage impeller:
$${β}_{j \_ 1} = arc tan \frac{4 {k}_{1} Q / [ π ( 1 - {d}_{sh}^{2} ) {D}_{s \_ 1}^{2} ]}{π {D}_{s \_ 1} {n}_{rotating} / 60} ;$$
wherein k₁ is a second coefficient;
the rim outlet placement angle β_{c_1} of the 1^{st} stage impeller:
$${β}_{c \_ 1} = arc tan \frac{4 {k}_{2} Q / [ π ( 1 - {d}_{sh} ) {D}_{s \_ 1}^{2} ]}{π {D}_{s} {n}_{rotating} / 60 - 60 g ( {P}_{1} / ( {ρ}_{mix} g ( 1 - {α}_{1} ) ) ) / π {D}_{s \_ 1} {n}_{rotating}} + Δ β$$
wherein k₂ is a third coefficient; ρₘᵢₓ is a density of a gas-liquid mixture, ρₘᵢₓ=ρ₁(1−α₁)+ρ_{g}α₁, and Δβ is an angle of attack;
the hub cone angle θ₁ of the 1^{st} stage impeller is 6°-12°; and
the 1^{st} stage blade wrap angle φ₁ is 100°-200°.

9. The stage-by-stage hydraulic design method for the impellers of the multistage gas-liquid multiphase pump according to claim 6, wherein when the gas content αᵢ of the i^{th} stage impeller is greater than 10%, the structural parameters of the impellers of the different pressurization stages are corrected respectively, as follows:
the different pressurization stages adopt a same inlet and outlet diameter and a same hub ratio for the impellers;
a correction method for a rim inlet placement angle β_{j_i} of the i^{th} stage impeller meets the following equation:
$${β}_{j \_ 1} = \sqrt{\frac{{Q}_{i}}{{Q}_{1}}} {β}_{j \_ 1} ;$$
a correction method for a rim outlet placement angle β_{c_i} of the i^{th} stage impeller meets the following equation:
$${β}_{c \_ i} = \frac{{P}_{i} / [ {ρ}_{mix} ( 1 - {α}_{i} ) ]}{{P}_{1} / [ {ρ}_{mix} ( 1 - {α}_{i} ) ]} {β}_{c \_ 1} ;$$
a correction method for a hub cone angle θᵢ₊₁ of the i^{th} stage impeller meets the following equation:
$${θ}_{i + 1} = {k}_{3} \sqrt{\frac{{α}_{i + 1}}{{α}_{i}}} {θ}_{i} ,$$
wherein k₃ is a fourth coefficient; and
an i^{th} stage blade wrap angle φᵢ is 100°-200°, and as the gas content of each of the different pressurization stages decreases stage by stage, φᵢ gradually decreases.

10. An impeller of a multistage gas-liquid multiphase pump, wherein the impeller is determined by the stage-by-stage hydraulic design method for the impellers of the multistage gas-liquid multiphase pump according to claim 1.
